(19) United States
(12) Patent Application Publication
(10) Pub. No.: US 2020/0052790 A1
(43) Pub. Date: Feb. 13, 2020

(54) UPPER DEVICE, OPPOSING DEVICE, COMMUNICATION SYSTEM, AND COMMUNICATION METHOD

(71) Applicant: SUMITOMO ELECTRIC INDUSTRIES, LTD., Osaka-shi, Osaka (JP)

(72) Inventor: Yuta NOMURA, Osaka-shi, Osaka (JP)

(73) Assignee: SUMITOMO ELECTRIC INDUSTRIES, LTD., Osaka-shi, Osaka (JP)

(21) Appl. No.: 15/736,486

(22) PCT Filed: Mar. 22, 2017
(86) PCT No.: PCT/JP2017/011421

§ 371 Date: Dec. 14, 2017

(51) Int. Cl. H04B 10/27; H04B 10/40; H04B 10/80

(52) U.S. Cl. CPC H04B 10/27; H04J 14/02; H04B 10/80; H04B 10/40

(57) ABSTRACT

The present invention discloses an upper device connected to an opposing device by a communication line which is a carrier signal transmission line. The upper device includes one or a plurality of transceivers that mutually convert a carrier signal and an electrical signal; a line concentrator that has a first port for an upper network, a second port for the transceiver, and a third port for management communication, and sets a communication path between the ports; and a control unit for management communication connected to the third port. When there is no response message from the opposing device within a predetermined period of time after the control unit inputs a management frame destined for the opposing device and including control information for the opposing device, to the third port, the control unit reinputs the management frame to the third port.

### TECHNICAL FIELD

The present invention relates to an upper device, an opposing device, a communication system, and a communication method which are suitable for a PON system, for example.

### BACKGROUND ART

In recent years, there has been a strong demand for the extension of a transmission distance for a passive optical network (PON) optical communication system. In view of this, there is a case in which an optical signal relay device is interposed between an optical line terminal (OLT) and an optical splitter or between the optical splitter and optical network units (ONUs) (see Patent Literature 1).

The optical signal relay device is an optical device that converts an optical signal into a relay signal by an optical-to-electrical converter and optically converts the converted relay signal again by an electrical-to-optical converter and then relays the signal.

The optical signal relay device converts a received optical signal into an electrical signal and outputs the electrical signal as a reconstructed signal in accordance with a reference clock. Hence, PON communication frames can be relayed as they are without changing their order and format.

### CITATION LIST

### Patent Literature

Patent Literature 1: Japanese Unexamined Patent Publication No. 2011-239144

### SUMMARY OF INVENTION

(1) A device according to one aspect of the present disclosure is an upper device connected to an opposing device by a communication line, the communication line being a carrier signal transmission line, the upper device including: one or a plurality of transceivers that mutually convert a carrier signal and an electrical signal; a line concentrator that has a first port for an upper network, a second port for the transceiver, and a third port for management communication, and sets a communication path between the ports; and a control unit for management communication connected to the third port, wherein when there is no response message from the opposing device within a predetermined period of time after the control unit inputs a management frame to the third port, the control unit reinputs the management frame to the third port, the management frame being destined for the opposing device and including control information for the opposing device.

(2) A device according to another aspect of the present disclosure is an opposing device connected to an upper device by a communication line, the communication line being a carrier signal transmission line, the opposing device including: one or a plurality of transceivers that mutually convert a carrier signal and an electrical signal; one or a plurality of optical transceivers that mutually convert an optical signal and an electrical signal; a PON processing unit electrically connected to the optical transceiver; a line concentrator that has a first port for the transceiver, a second port for the PON processing unit, and a third port for management communication, and sets a communication path between the ports; and a control unit for management communication connected to the third port, wherein when there is an error in a management frame, the control unit discards the management frame, and when there is no error, the control unit inputs a response message destined for the upper device to the third port, the management frame being obtained from the third port and including control information for the opposing device.

(3) A system according to one aspect of the present disclosure is a communication system including: an upper device including a line concentrator linked to an upper network; and an opposing device including a PON processing unit, the upper device and the opposing device being connected to each other in a communicable manner by a communication line, the communication line being a carrier signal transmission line, wherein the upper device and the opposing device each are provided with a control unit for management communication for transmitting and receiving a management frame through the communication line without any error, the management frame being destined for the opposing device and including control information for the opposing device.

(4) A method according to one aspect of the present disclosure is a communication method for a communication system having an upper device including a line concentrator linked to an upper network; and an opposing device including a PON processing unit, the upper device and the opposing device being connected to each other in a communicable manner by a communication line, the communication line being a carrier signal transmission line, the communication method including: transmitting and receiving a management frame through the communication line without any error, the management frame being destined for the opposing device and including control information for the opposing device.

The present invention can not only be implemented as a system and devices that include characteristic configurations such as those described above, but also be implemented as a program for causing a computer to carry out the characteristic configurations.

In addition, the present invention can be implemented as a semiconductor integrated circuit that implements a part or all of the system or devices.

### BRIEF DESCRIPTION OF DRAWINGS

FIG. 1 is a schematic configuration diagram of a PON system according to an embodiment of the present invention.

FIG. 2 is a block diagram showing an example of the internal configurations of an upper device and an opposing device.

FIG. 3 is a sequence diagram showing an example of an IP address assignment process based on the DHCP which is performed between the upper device and the opposing device.

FIG. 4 is a sequence diagram showing an example of a management frame transmission and reception process between the upper device and the opposing device.

### DESCRIPTION OF EMBODIMENTS

### Problem to be Solved by the Present Disclosure

As pointed out in Patent Literature 1, too, the optical signal relay device has a problem that, when the optical signal relay device relays optical signals with different transmission rates, the time required for error-correction coding and coding varies depending on the transmission rate. Hence, there is required a special measure for solving such a problem.

In view of this, for example, a system configuration may be adopted in which the components of a single OLT is separated into an upper device having a line concentrator linked to an upper network and an opposing device having PON processing units, and the devices communicate with each other through an optical communication line.

By doing so, the transmission distance from the upper device in an office building to ONUs at users' homes can be extended by an amount equal to the length of the optical communication line between the upper device and the opposing device, without reproducing PON communication frames as they are like the optical signal relay device.

However, when the line concentrator is physically separated from the PON processing units and the opposing device having mounted thereon the PON processing units is installed at a remote site, another problem such as that shown below may occur depending on the length of the optical communication line.

Specifically, when the opposing device is remote controlled by transmitting a management frame including control information for the opposing device through the optical communication line, if an error occurs in the management frame due to optical signal attenuation, etc., then there is a possibility that the opposing device may not be able to be appropriately controlled.

In view of such a conventional problem, an object of the present disclosure is to allow to appropriately manage an opposing device even if an OLT is separated into an upper device and the opposing device, regardless of the distance between the devices.

### Advantageous Effects of the Present Disclosure

According to the present disclosure, even if the components of an OLT are separated into an upper device and an opposing device, the opposing device can be appropriately managed regardless of the distance between the devices.

### Summary of an Embodiment of the Present Invention

A summary of an embodiment of the present invention will be listed and described below.

(1) A device according to one aspect of the present embodiment is an upper device connected to an opposing device by a communication line, the communication line being a carrier signal transmission line, the upper device including: one or a plurality of transceivers that mutually convert a carrier signal and an electrical signal; a line concentrator that has a first port for an upper network, a second port for the transceiver, and a third port for management communication, and sets a communication path between the ports; and a control unit for management communication connected to the third port, wherein when there is no response message from the opposing device within a predetermined period of time after the control unit inputs a management frame to the third port, the control unit reinputs the management frame to the third port, the management frame being destined for the opposing device and including control information for the opposing device.

(2) A device according to another aspect of the present embodiment is an opposing device connected to an upper device by a communication line, the communication line being a carrier signal transmission line, the opposing device including: one or a plurality of transceivers that mutually convert a carrier signal and an electrical signal; one or a plurality of optical transceivers that mutually convert an optical signal and an electrical signal; a PON processing unit electrically connected to the optical transceiver; a line concentrator that has a first port for the transceiver, a second port for the PON processing unit, and a third port for management communication, and sets a communication path between the ports; and a control unit for management communication connected to the third port, wherein when there is an error in a management frame, the control unit discards the management frame, and when there is no error, the control unit inputs a response message destined for the upper device to the third port, the management frame being obtained from the third port and including control information for the opposing device.

According to the upper device of the present embodiment, when there is no response message from the opposing device within a predetermined period of time after the control unit inputs a management frame destined for the opposing device and including control information for the opposing device, to the third port of the line concentrator of the upper device, the control unit reinputs the management frame to the third port.

According to the opposing device of the present embodiment, when there is an error in a management frame obtained from the third port of the line concentrator of the opposing device and including control information for the opposing device, the control unit discards the management frame, and when there is no error, the control unit inputs a response message destined for the upper device to the third port.

Hence, a management frame destined for the opposing device and including control information for the opposing device can be transmitted and received through the communication line without any error.

Accordingly, in a communication layer higher than a transport layer, it is apparently considered that the upper device has transmitted the management frame to the opposing device without any error, and thus, a communication system composed of the upper device, the communication line, and the opposing device can be allowed to function as a single virtual OLT. Thus, even if an OLT is separated into an upper device and an opposing device, the opposing device can be appropriately managed regardless of the distance between the devices.

(3) A communication system of the present embodiment is a communication system including: an upper device including a line concentrator linked to an upper network; and an opposing device including a PON processing unit, the upper device and the opposing device being connected to each other in a communicable manner by a communication line, the communication line being a carrier signal transmission line, wherein the upper device and the opposing device each are provided with a control unit for management communication for transmitting and receiving a management frame through the communication line without any error, the management frame being destined for the opposing device and including control information for the opposing device.

According to the communication system of the present embodiment, the upper device and the opposing device each are provided with a control unit for management communication for transmitting and receiving a management frame destined for the opposing device and including control information for the opposing device, through the communication line without any error. Thus, a communication system composed of the upper device, the communication line, and the opposing device can be allowed to function as a single virtual OLT.

Accordingly, even if an OLT is separated into an upper device and an opposing device, the opposing device can be appropriately managed regardless of the distance between the devices.

(4) A communication method of the present embodiment is a communication method for a communication system having an upper device including a line concentrator linked to an upper network; and an opposing device including a PON processing unit, the upper device and the opposing device being connected to each other in a communicable manner by a communication line, the communication line being a carrier signal transmission line, the communication method including: transmitting and receiving a management frame through the communication line without any error, the management frame being destined for the opposing device and including control information for the opposing device.

According to the communication method of the present embodiment, a management frame destined for the opposing device and including control information for the opposing device is transmitted and received through the communication line without any error. Thus, a communication system composed of the upper device, the communication line, and the opposing device can be allowed to function as a single virtual OLT.

Accordingly, even if an OLT is separated into an upper device and an opposing device, the opposing device can be appropriately managed regardless of the distance between the devices.

### A Detail of an Embodiment of the Present Invention

A detail of an embodiment of the present invention will be described below with reference to the drawings. Note that at least part of the embodiment described below may be arbitrarily combined.

[Overall Configuration of a PON System]

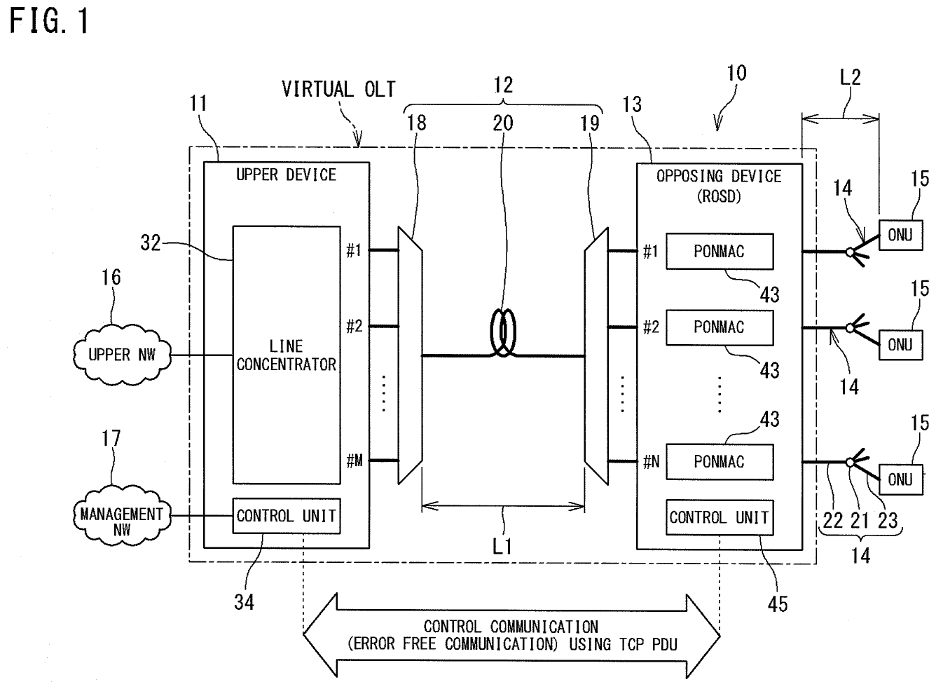

FIG. 1 is a schematic configuration diagram of a PON system 10 according to an embodiment of the present invention.

As shown in FIG. 1, the PON system 10 of the present embodiment includes an upper device 11 installed in an office building of a telecommunications carrier, etc.; an opposing device 13 that communicates with the upper device 11 through an optical communication line 12; PON lines 14 connected to the opposing device 13; and a plurality of optical network units (ONUs) 15 connected to the respective ends on the lower side of the PON lines 14.

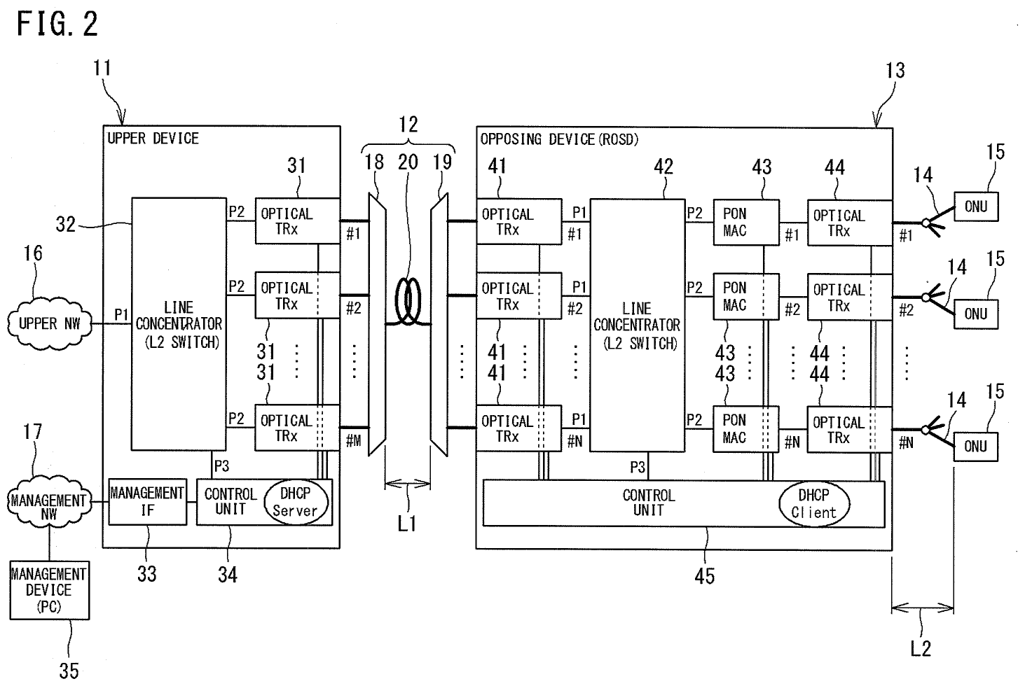

The upper device 11 is connected to an upper network 16 composed of a core network, etc., and to a management network 17 which is linked to a management device 35 of the telecommunications carrier (see FIG. 2).

The optical communication line 12 is composed of, for example, a dense wavelength division multiplexing (DWDM) communication line. The optical communication line 12 has a multiplexer/demultiplexer 18 on the upper side; a multiplexer/demultiplexer 19 on the lower side; and a single optical fiber 20 that connects the multiplexers/demultiplexers 18 and 19. Optical signals of a plurality of wavelengths in upstream and downstream directions are transmitted through the optical fiber 20 such that the optical signals are densely multiplexed.

The multiplexer/demultiplexer 18 on the upper side is installed in the office building of the telecommunications carrier, etc., and the number of wavelengths is M channels (M is a natural number greater than or equal to 2). The multiplexer/demultiplexer 19 on the lower side is installed in the same location as or in the neighborhood of the opposing device 13, and the number of wavelengths is N channels (N is a natural number greater than or equal to 2).

In the PON system 10 of the present embodiment, the numbers of channels of the multiplexers/demultiplexers 18 and 19 are set such that M≥N. The opposing device 13 can connect thereto such number of PON lines 14 that corresponds to the number of channels N of the multiplexer/demultiplexer 19 on the lower side.

User terminals (not shown) that can perform Ethernet (“Ethernet” is a registered trademark.) communication can be connected to the ONUs 15. The number and type of user terminals to be connected to the ONUs 15 are not particularly limited. It is not essential either that user terminals be directly connected to the ONUs 15.

A user network (not shown) may be connected to each ONU 15. A user terminal may be connected to the ONU 15 through the user network.

Each PON line 14 is composed of a communication line including an optical splitter 21 and optical fibers 22 and 23. The PON line 14 includes one trunk optical fiber 22 and a plurality of branch optical fibers 23. The optical fibers 22 and 23 are connected to the optical splitter 21.

A downstream optical signal transmitted from the opposing device 13 passes through the trunk optical fiber 22 of a corresponding PON line 14 and is split by the optical splitter 21. The split optical signals pass through the branch optical fibers 23 and are transmitted to each ONU 15.

Optical signals in the upstream direction which are transmitted from the respective ONUs 15 pass through the branch optical fibers 23 and are converged by the optical splitter 21. The converged optical signals pass through the trunk optical fiber 22 and are transmitted to the opposing device 13.

The optical splitter 21 used for each PON line 14 does not particularly require external power supply, and passively splits or multiplexes an inputted optical signal(s).

The optical signals in the upstream direction which are transmitted to the branch optical fibers 23 are merged at the optical splitter 21. Therefore, there is required multiplexing for preventing the collision of optical signals of the same wavelength after merging.

In the PON system 10, time division multiplexing conforming to the multi-point control protocol (MPCP) is performed. In the present embodiment, each PON media access controller (PONMAC) 43 mounted on the opposing device 13 computes, based on reports received from ONUs 15, the transmission start times and amounts of transmission allowed for data in the upstream direction from the ONUs 15.

The PONMAC 43 transmits grants including the above-described times and amounts of transmission allowed, to the ONUs 15, respectively, through the PON line 14.

When each ONU 15 receives the grant from the PONMAC 43, the ONU 15 transmits, at the time specified by the grant, data whose amount corresponds to the amount of transmission allowed, and a report requesting the amount of data for the next transmission which corresponds to the amount of data in a buffer of the ONU 15, to the PONMAC 43.

In addition to the above, each PONMAC 43 performs, for example, a discovery process for detecting an ONU 15 connected to a PON line 14 which the PONMAC 43 is in charge of, and a registration process for registering a logical link ID (LLID) of the detected ONU 15 therein.

As shown in FIG. 1, a line concentrator 32 linked to the upper network 16 is mounted on the upper device 11, and the PONMACs 43 each performing PON control on ONUs 15 thereunder are mounted on the opposing device 13.

Then, by performing data communication between the line concentrator 32 and the PONMACs 43 through a communication path using the optical communication line 12, a configuration is formed in which a line concentration function portion on the upper side and a PON control portion on the lower side of a normal OLT are physically separated from each other.

Therefore, the opposing device 13 can be installed in a building (not shown) located a first distance L1 away from the upper device 11 installed in the office building, or can be installed outdoors. For example, the first distance L1 can be set to several tens of kilometers to 100 kilometers.

A second distance L2 (the maximum distance of the PON lines 14) from the opposing device 13 to the ONUs 15 is, for example, on the order of 20 km because there is optical signal attenuation due to the splitting of the PON lines 14.

As such, the PON system 10 of the present embodiment adopts a system configuration in which the components of a single OLT are separated into the upper device 11 having the line concentrator 32 and the opposing device 13 having the PONMACs 43, and the devices 11 and 13 communicate with each other through the optical communication line 12.

Hence, the transmission distance from the upper device 11 in the office building to the ONUs 15 at users' homes can be extended by the first distance L1 of the optical communication line 12 that connects the upper device 11 to the opposing device 13, without reproducing PON communication frames as they are like an optical signal relay device.

However, when the line concentrator 32 is physically separated from the PONMACs 13 and the opposing device 13 having mounted thereon the PONMACs 13 is installed at a remote site, the following problem may occur depending on the length of the first distance L1 of the optical communication line 12.

Specifically, when the opposing device 13 is remote controlled by transmitting a management frame including control information for the opposing device 13 through the optical communication line 12, if an error occurs in the management frame due to optical signal attenuation, etc., then there is a possibility that the opposing device 13 may not be able to be appropriately controlled.

In view of this, in the present embodiment, by providing control units 34 and 45 for management communication in the devices 11 and 13, respectively, the transmission of a management frame including control information to the opposing. device 13 without any error is enabled. The control units 34 and 45 performs, for example, control communication (error free communication) using a management frame based on the transmission control protocol (TCP).

Hence, even if the first distance L1 is set to a long distance, e.g., 100 km, a communication system composed of the upper device 11, the optical communication line 12, and the opposing device 13 functions as a virtual OLT which looks as if the communication system belongs to a single casing.

The details of the internal configurations of the upper device 11 and the opposing device 13 of the present embodiment will be described below.

Note that in the following description the “opposing device” is also referred to as “ROSD” (remote optical service device).

[Internal Configuration of the Upper Device]

FIG. 2 is a block diagram showing an example of the internal configurations of the upper device 11 and the opposing device (ROSD) 13.

As shown in FIG. 2, the upper device 11 includes a plurality of optical transceivers 31, the line concentrator 32, a management interface 33, and the control unit 34 for management communication.

Each optical transceiver 31 is composed of an optical device (e.g., a pluggable optical transceiver) including a circuit that transmits and receives optical signals. The optical transceiver 31 is optically connected to an optical fiber on the demultiplexing side of the multiplexer/demultiplexer 18, and is electrically connected to any one of communication ports of the line concentrator 32. Such number of optical transceivers 31 that is equal to the number of channels M of the multiplexer/demultiplexer 18 can be present.

The optical transceiver 31 converts an upstream optical signal from the multiplexer/demultiplexer 18 into an electrical signal. The optical transceiver 31 converts a downstream electrical signal from the line concentrator 32 into an optical signal.

The line concentrator 32 is composed of, for example, an L2 (layer 2) switch. The switch includes an integrated circuit, e.g., a field-programmable gate array (FPGA), that sets a communication path between communication ports P1 to P3, according to the destination of a received layer-2 communication frame.

The communication ports of the line concentrator 32 include the first port P1 for the upper network 16; the second ports P2 for the optical transceivers 31; and the third port P3 for the control unit 34 for management communication.

When a communication frame included in a downstream signal from the upper network 16 is a data frame destined for a PONMAC 43, the line concentrator 32 transmits the data frame to a predetermined optical transceiver 31 relevant to the PONMAC 43.

When a communication frame included in an upstream signal from each optical transceiver 31 is a data frame to the upper network 16, the line concentrator 32 transmits the data frame to the upper network 16.

When a communication frame included in an upstream signal from a predetermined optical transceiver 31 (e.g., #1) is a communication frame whose source is the control unit 45 of the opposing device 13, the line concentrator 32 transmits the communication frame to the control unit 34 thereof.

When a communication frame included in an electrical signal from the control unit 34 of the line concentrator 32 is a communication frame destined for the control unit 45 of the opposing device 13, the line concentrator 32 transmits the communication frame to a predetermined optical transceiver 31 (e.g., #1).

The line concentrator 32 can change a quality-of-service (QoS) parameter of a downstream signal on a per optical transceiver 31 basis.

For example, the line concentrator 32 adjusts the amount of data communicated for a downstream signal to be sent out to each optical transceiver 31 such that the value of a QoS parameter (e.g., maximum communication bandwidth (Mbps)) which is instructed by the control unit 34 is obtained.

The above-described value of the QoS parameter is, for example, manually inputted to the management device 35 by a person in charge at the telecommunications carrier.

The management device 35 transmits a management frame including the above-described input value to the control unit 34 of the upper device 11. The control unit 34 of the upper device 11 gives an instruction for the parameter value included in the received management frame to the line concentrator 32.

The control unit 34 is composed of an information processing device including a central processing unit (CPU). The control unit 34 may include either one or a plurality of CPUs. The control unit 34 may include an integrated circuit such as an FPGA or an application specific integrated circuit (ASIC).

The control unit 34 includes a random access memory (RAM). The RAM is composed of a memory device such as a static RAM (SRAM) or a dynamic RAM (DRAM), and temporarily stores computer programs to be executed by the CPU, etc., and data required for the execution.

The control unit 34 includes a storage device having a nonvolatile memory device such as a flash memory or an electrically erasable programmable read only memory (EEPROM).

The storage device stores a network OS and various application software (hereinafter, abbreviated as “applications”) that run on the OS. The applications stored in the storage device include software for allowing the control unit 34 to function as a “dynamic host configuration protocol (DHCP) server”.

The applications stored in the storage device also include software for allowing the control unit 34 to function as a communication unit that performs the creation and transmission/reception of a management frame based on the TCP.

Therefore, by the CPU executing the software read from the storage device, the control unit 34 can operate as a DHCP server and a TCP protocol data unit (PDU) transmitting and receiving unit.

The management interface 33 is a communication device that communicates with the management device 35, according to a predetermined communication standard. The management interface 33 communicates with the management device 35 through the management network 17 composed of a public communication network, a private communication network, and the like.

The management device 35 is composed of, for example, a server computer device which is operated by a user such as a network administrator of the telecommunications carrier.

The management device 35 is connected through the management network 17 to the management interface 33 of the upper device 11 in a communicable manner. However, the communication between the management device 35 and the management interface 33 may be direct communication without through the management network 17, or may be either wired communication or wireless communication.

Note that the internal configuration of the upper device 11 is not limited to that of FIG. 2. For example, the line concentrator 32 and the control unit 34 may be integrated into a single integrated circuit.

[Internal Configuration of the Opposing Device (ROSD)]

As shown in FIG. 2, the opposing device (ROSD) 13 includes a plurality of optical transceivers 41 on the upper side, a line concentrator 42, the plurality of PONMACs 43, a plurality of optical transceivers 44 on the lower side, and the control unit 45 for management communication.

Each optical transceiver 41 is composed of (e.g., a pluggable optical transceiver) including a circuit for transmitting and receiving optical signals. The optical transceiver 41 is optically connected to an optical fiber on the demultiplexing side of the multiplexer/demultiplexer 19, and is electrically connected to any one of communication ports of the line concentrator 42. Such number of optical transceivers 41 that is equal to the number of channels N of the multiplexer/demultiplexer 20 can be present.

The optical transceiver 41 converts a downstream optical signal from the multiplexer/demultiplexer 20 into an electrical signal. The optical transceiver 41 converts an upstream electrical signal from the line concentrator 32 into an optical signal.

The line concentrator 42 is composed of, for example, an L2 switch. The switch includes an integrated circuit, e.g., an FPGA, that sets a communication path between the communication ports, according to the destination of a received layer-2 communication frame.

The communication ports of the line concentrator 32 include first ports P1 for the optical transceivers 41 on the upper side; second ports P2 for the PONMACs 43; and a third port P3 for the control unit 45 for management communication.

When a communication frame included in a downstream signal from each optical transceiver 41 is a data frame destined for a PONMAC 43, the line concentrator 42 transmits the data frame from a communication port having the PONMAC 43 connected thereto.

When a communication frame included in an upstream signal from each PONMAC 43 is a data frame to the upper network 16, the line concentrator 42 transmits the data frame to a predetermined optical transceiver 41 which is set in advance.

When a communication frame included in a downstream signal from a predetermined optical transceiver 41 (e.g., #1) is a communication frame whose source is the control unit 34 of the upper device 11, the line concentrator 42 transmits the communication frame to the control unit 45 thereof.

When a communication frame included in an electrical signal from the control unit 45 of the line concentrator 42 is a communication frame destined for the control unit 34 of the upper device 11, the line concentrator 42 transmits the communication frame to a predetermined optical transceiver 41 (e.g., #1).

The line concentrator 42 can change a QoS parameter of an upstream signal on a per optical transceiver 41 basis.

For example, the line concentrator 42 adjusts the amount of data communicated for an upstream signal to be sent out to each optical transceiver 41 such that the value of a QoS parameter (e.g., maximum communication bandwidth (Mbps)) which is instructed by the control unit 45 is obtained.

The above-described value of the QoS parameter is, for example, manually inputted to the management device 35 by a person in charge at the telecommunications carrier.

The management device 35 transmits a management frame including the above-described input value to the control unit 34 of the upper device 11. The control unit 34 of the upper device 11 transmits a management frame including the parameter value included in the received management frame to the control unit 45 of the ROSD 13. The control unit 45 of the ROSD 13 gives an instruction for the parameter value included in the received management frame to the line concentrator 42.

The control unit 45 is composed of an information processing device including a CPU. The control unit 45 may include either one or a plurality of CPUs. The control unit 45 may include an integrated circuit such as an FPGA or an ASIC.

The control unit 45 includes a RAM. The RAM is composed of a memory device such as an SRAM or a DRAM, and temporarily stores computer programs to be executed by the CPU, etc., and data required for the execution.

The control unit 45 includes a storage device having a nonvolatile memory device such as a flash memory or an EEPROM.

The storage device stores a network OS and various applications that run on the OS. The applications stored in the storage device include software for allowing the control unit 45 to function as a “DHCP client”.

The applications stored in the storage device also include software for allowing the control unit 45 to function as a communication unit that performs the creation and transmission/reception of a management frame based on the TCP.

Therefore, by the CPU executing the software read from the storage device, the control unit 45 can operate as a DHCP client and a TCP PDU transmitting and receiving unit.

Each optical transceiver 44 is composed of an optical device (e.g., a pluggable optical transceiver) including a circuit that transmits and receives optical signals. The optical transceiver 44 is optically connected to a trunk optical fiber 22 of a. corresponding PON line 14, and is electrically connected to a corresponding PONMAC 43. Such number of optical transceivers 44 that is equal to the number of channels M of the multiplexer/demultiplexer 20 can be present.

The optical transceiver 44 converts an upstream optical signal from the PON line 14 into an electrical signal. The optical transceiver 44 converts a downstream electrical signal from the PONMAC 43 into an optical signal.

Each PONMAC 43 is composed of an integrated circuit that performs information processing concerning PON control on a downstream signal and an upstream signal. For example, the PONMAC 43 transmits a data frame included in a downstream electrical signal from the line concentrator 42, to a corresponding optical transceiver 44.

When an upstream electrical signal from an optical transceiver 44 includes a data frame to be transmitted to the upper network, a corresponding PONMAC 43 transmits the data frame to the line concentrator 42.

When an upstream electrical signal from an optical transceiver 44 includes a control frame (report) whose source is an ONU 15, a corresponding PONMAC 43 creates a control frame (grant) for the ONU 15, the source, based on the report and transmits the control frame to the optical transceiver 44.

Note that the internal configuration of the ROSD 13 is not limited to that of FIG. 2. For example, the line concentrator 42, the plurality of PONMACs 43, and the control unit 45 may be integrated into a single integrated circuit.

[IP Address Assignment Process]

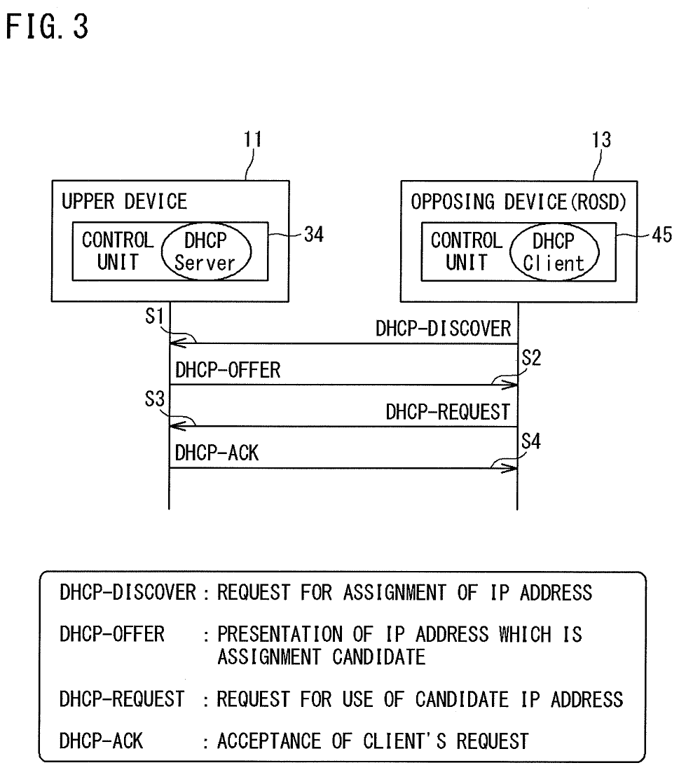

FIG. 3 is a sequence diagram showing an example of an IP address assignment process based on the DHCP which is performed between the upper device 11 and the opposing device (ROSD) 13.

As shown in FIG. 3, when the ROSD. 13 is activated by power on, etc., the control unit 45 (DHCP client) of the ROSD 13 broadcasts a message (DHCP-DISCOVER) for requesting the assignment of an IP address (step S1).

The control unit 34 (DHCP server) of the upper device 11 having received the message at step S1 returns a message (DHCP-OFFER) including an IP address which is an assignment candidate, to the control unit 45 of the ROSD 13 (step S2).

The control unit 45 of the ROSD 13 having received the message at step S2 selects the candidate address included in the message, as an IP address of the ROSD 13 and transmits a message (DHCP-REQUEST) for requesting the use of the address to the control unit 34 of the upper device 11.

The control unit 34 of the upper device 11 having received the message at step S3 returns a message (DHCP-ACK) for accepting the request on the client side to the control unit 45 of the ROSD 13 (step S4).

The message at step S4 also includes other option information defined in the DHCP. The control unit 45 of the ROSD 13 having received the message at step S4 constructs TCP/IP based on the DHCP option information, and participates in the network.

As described above, in the PON system 10 of the present embodiment, the upper device 11 dynamically assigns an IP address to the activated ROSD 13, and the ROSD 13 obtains the IP address notified by the upper device 11.

Therefore, when an IP address on the ROSD 13 side is determined by the assignment process of FIG. 3, it becomes possible for the control unit 34 of the upper device 11 and the control unit 45 of the ROSD 13 to perform the transmission and reception of management frames based on the TCP.

[Management Frame Transmission and Reception Process]

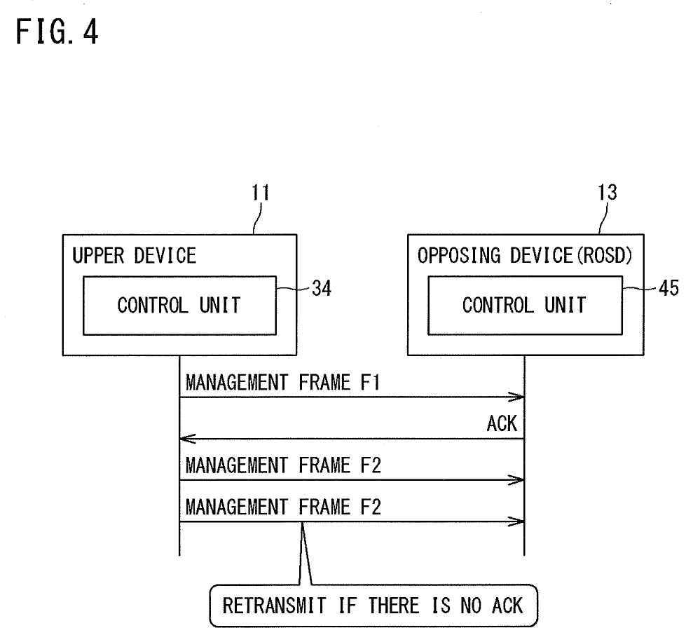

FIG. 4 is a sequence diagram showing an example of a management frame transmission and reception process between the upper device 11 and the opposing device (ROSD) 13.

In FIG. 4, a management frame Fi (i=1, 2 . . . ) indicates a management frame based on the TCP which is transmitted from the upper device 11 to the opposing device 13.

The management frame Fi based on the TCP which is transmitted from the upper device 11 to the ROSD 13 is broadly classified into the following first and second management frames:

First management frame: a management frame that includes control information for the ROSD 13

Second management frame: a management frame that does not include control information for the ROSD 13

For the first management frame, the control information needs to be transmitted without any error, and thus, the transmission and reception process of FIG. 4 is applied. Namely, the transmission and reception process of FIG. 4 is a transmission and reception process to be performed when the management frame Fi is the first management frame.

The second management frame does not necessarily need to be transmitted without any error. Thus, a communication process such as the same content is repeatedly and continuously transmitted or when an error occurs a predetermined number of times (e.g., twice) or more, retransmission is requested may be performed, and the transmission and reception process of FIG. 4 does not necessarily need to be applied.

The second management frame includes, for example, an open shortest path first (OSPF) Hello packet.

As shown in FIG. 4, when control information about the ROSD 13 is obtained from the management device 35 after an IP address is assigned to the control unit 45 of the ROSD 13, the control unit 34 of the upper device 11 creates a management frame (first management frame) Fi including the obtained control information, and transmits the management frame Fi to the control unit 45 of the ROSD 13.

Specifically, the control unit 34 of the upper device 11 inputs the management frame Fi to the third port P3 of the line concentrator 32.

The management frame Fi based on the TCP is transmitted in Ethernet frame format. An Ethernet frame has a 32-bit field called frame check sequence (FCS) for detecting an error. This field stores a cyclic redundancy check (CRC) value which is computed from a destination address, etc.

The Ethernet frame receiving side computes a CRC value in the same manner. If the CRC values do not match, then the Ethernet frame receiving side determines that there is an error, and thus, discards the Ethernet frame having an error.

For example, as shown in FIG. 4, when the control unit 45 of the ROSD 13 has not detected an error in a management frame F1 by a CRC check, the control unit 45 of the ROSD 13 transmits a response message (ACK) indicating that the management frame F1 has been received normally, to the control unit 34 of the upper device 11.

Specifically, the control unit 45 of the ROSD 13 inputs the response message to the third port P3 of the line concentrator 42. When the control unit 45 of the ROSD 13 has detected an error in a management frame F2 by a CRC check, the control unit 45 of the ROSD 13 discards the management frame F2.

The control unit 34 of the upper device 11 and the control unit 45 of the ROSD 13 operate based on the TCP. Hence, the management frame F2 is discarded by error detection and if a response message from the ROSD 13 is not received within a predetermined period of time (e.g., one second), then the control unit 34 of the upper device 11 retransmits the management frame F2 to the control unit 45 of the ROSD 13.

Specifically, the control unit 34 of the upper device 11 reinputs the management frame F2 to the third port P3 of the line concentrator 32.

Therefore, in a communication layer higher than a transport layer, it is apparently recognized that the upper device 11 has transmitted the management frame Fi (i=1, 2 . . . ) to the ROSD 13 without any error.

In the transmission and reception process of FIG. 4, when the control unit 45 of the ROSD 13 has detected an error in the management frame F2, the control unit 45 of the ROSD 13 may not only discard the management frame F2 but also transmit a negative acknowledgement (NACK) message to the control unit 34 of the upper device 11.

By doing so, the upper device 11 can be prompted to retransmit the management frame F2 promptly. Thus, there is an advantage in that the error fixing time can be reduced over a case in which the management frame F2 is just discarded.

[Types of Control Information]

In the PON system 10 of the present embodiment, control information to be included in a management frame which is transmitted to the upper device 11 by the management device 35 is broadly classified into control information about the upper device 11 and control information about the ROSD 13.

For the control information about the upper device 11, for example, the following information 1 to 3 can be adopted:

Information 1) Assignment information of the communication ports P1 to P3 for the line concentrator 32

Information 2) A QoS parameter of a downstream signal for the line concentrator 32

Information 3) On/off setting information for the optical transceivers 31

For the control information about the ROSD 13, for example, the following information 4 to 7 can be adopted:

Information 4) Assignment information of the communication ports P1 to P3 for the line concentrator 42

Information 5) A QoS parameter of an upstream signal for the line concentrator 42

Information 6) On/off setting information for the optical transceivers 41 and 44

Information 7) A set parameter (a guaranteed minimum bandwidth, etc.) for upstream-direction dynamic bandwidth allocation (DBA) for a PONMAC 43

When a management frame received by the control unit 34 of the upper device 11 includes any one of the information 1 to 3 which are control information about the upper device 11, the control unit 34 of the upper device 11 performs control according to the content of the one of the information 1 to 3 on each unit included in the upper device 11.

For example, when the control unit 34 of the upper device 11 obtains the information 3, the control unit 34 of the upper device 11 turns on or off the optical transceivers 31 according to set information described in the information 3. By this, only an optical transceiver 31 provided for a wavelength to be used can be allowed to operate.

When a management frame received by the control unit 34 of the upper device 11 includes any one of the information 4 to 7 which are control information about the ROSD 13, the control unit 34 of the upper device 11 creates a management frame Fi including the one of the information 4 to 7, and transmits the management frame Fi to the control unit 45 of the ROSD 13.

When a management frame Fi received by the control unit 45 of the ROSD 13 includes any one of the information 4 to 7, the control unit 45 of the ROSD 13 performs control according to the content of the one of the information 4 to 7 on each unit included in the ROSD 13.

For example, when the control unit 45 of the ROSD 13 obtains the information 7, the control unit 45 of the ROSD 13 notifies a corresponding PONMAC 47 of a set parameter described in the information 7. By this, the content of DBA in the upstream direction for a corresponding PON line 14 that is performed by the PONMAC 47 can be changed.

### Advantageous Effects of the Present Embodiment

As described above, according to the PON system 10 of the present embodiment, when there is no response message from the ROSD 13 within a predetermined period of time after the control unit 34 of the upper device 11 inputs a management frame F2 destined for the ROSD 13 and including control information for the ROSD 13, to the third port P3 of the line concentrator 32, the control unit 34 of the upper device 11 reinputs the management frame F2 to the third port P3 of the line concentrator 32.

In addition, when there is an error in the management frame F2 obtained from the third port P3 of the line concentrator 42 and including control information for the ROSD 13, the control unit 45 of the ROSD 13 discards the management frame F2, and when there is no error, the control unit 45 of the ROSD 13 inputs a response message destined for the upper device 11 to the third port P3 of the line concentrator 42.

Hence, a management frame Fi destined for the ROSD 13 and including control information for the ROSD 13 can be transmitted and received through the optical communication line 12 without any error.

Accordingly, in the communication layer higher than the transport layer, it is apparently considered that the upper device 11 has transmitted the management frame Fi to the ROSD 13 without any error, and thus, a communication system composed of the upper device 11, the optical communication line 12, and the opposing device 13 can be allowed to function as a single virtual OLT. Thus, even if an OLT is separated into the upper device 11 and the opposing device 13, the opposing device 13 can be appropriately managed regardless of the distance between the devices 11 and 13.

[Other Variants]

The above-described embodiment is in all respects as illustrative and not restrictive. The scope of the present invention is indicated by the claims, and all changes which come within the meaning and range of equivalency of the claims are therefore intended to be embraced therein.

For example, in the above-described embodiment, the control unit 34 of the upper device 11 may obtain control information for the upper device 11 or for the opposing device 13 by communicating with the management device 35 connected to the upper network 16, through the line concentrator 32.

In this case, control information from the upper network 16 whose source is the management device 35 is transmitted to the control unit 34 via the port P2 and port P3 of the line concentrator 32. By thus transmitting control information via the upper network 16, the control information can be transmitted to the control unit 34 of the upper device 11 without providing the management interface 33 of the upper device 11.

In the above-described embodiment, the optical communication line 12 is not limited to an optical communication line of a WDM system, and may be an optical communication line that transmits optical signals of a single wavelength.

In addition, a carrier signal used for communication between the upper device 11 and the ROSD 13 is not limited to an optical signal. Namely, a communication line which is a carrier signal transmission line is not limited to the optical communication line 12 shown in the drawings, and may be other communication lines (e.g., a communication line using a coaxial cable).

### REFERENCE SIGNS LIST

10: PON SYSTEM
11: UPPER DEVICE
12: OPTICAL COMMUNICATION LINE
13: OPPOSING DEVICE
14: PON LINE
15: ONU (OPTICAL NETWORK UNIT)
16: UPPER NETWORK
17: MANAGEMENT NETWORK
18: MULTIPLEXER/DEMULTIPLEXER
19: MULTIPLEXER/DEMULTIPLEXER
20: OPTICAL FIBER
21: OPTICAL SPLITTER
22: TRUNK OPTICAL FIBER
23: BRANCH OPTICAL FIBER
31: OPTICAL TRANSCEIVER (TRANSCEIVER)
32: LINE CONCENTRATOR
33: MANAGEMENT INTERFACE
34: CONTROL UNIT
35: MANAGEMENT DEVICE
41: OPTICAL TRANSCEIVER (TRANSCEIVER)
42: LINE CONCENTRATOR
43: PONMAC (PON PROCESSING UNIT)
44: OPTICAL TRANSCEIVER
45: CONTROL UNIT

1. An upper device connected to an opposing device by a communication line, the communication line being a carrier signal transmission line, the upper device comprising:
one or a plurality of transceivers that mutually convert a carrier signal and an electrical signal;
a line concentrator that has a first port for an upper network, a second port for the transceiver, and a third port for management communication, and sets a communication path between the ports; and
a control unit for management communication connected to the third port, wherein
when there is no response message from the opposing device within a predetermined period of time after the control unit inputs a management frame to the third port, the control unit reinputs the management frame to the third port, the management frame being destined for the opposing device and including control information for the opposing device.

2. An opposing device connected to an upper device by a communication line, the communication line being a carrier signal transmission line, the opposing device comprising:
one or a plurality of transceivers that mutually convert a carrier signal and an electrical signal;
one or a plurality of optical transceivers that mutually convert an optical signal and an electrical signal;
a PON processing unit electrically connected to the optical transceiver;
a line concentrator that has a first port for the transceiver, a second port for the PON processing unit, and a third port for management communication, and sets a communication path between the ports; and
a control unit for management communication connected to the third port, wherein
when there is an error in a management frame, the control unit discards the management frame, and when there is no error, the control unit inputs a response message destined for the upper device to the third port, the management frame being obtained from the third port and including control information for the opposing device.

3. A communication system comprising: an upper device including a line concentrator linked to an upper network; and an opposing device including a PON processing unit, the upper device and the opposing device being connected to each other in a communicable manner by a communication line, the communication line being a carrier signal transmission line, wherein
the upper device and the opposing device each are provided with a control unit for management communication for transmitting and receiving a management frame through the communication line without any error, the management frame being destined for the opposing device and including control information for the opposing device.

4. A communication method for a communication system having an upper device including a line concentrator linked to an upper network; and an opposing device including a PON processing unit, the upper device and the opposing device being connected to each other in a communicable manner by a communication line, the communication line being a carrier signal transmission line, the communication method comprising:
transmitting and receiving a management frame through the communication line without any error, the management frame being destined for the opposing device and including control information for the opposing device.
